(19) United States
(12) Patent Application Publication
(10) Pub. No.: US 2025/0005569 A1
(43) Pub. Date: Jan. 2, 2025

(54) BLOCKCHAIN-BASED DATA PROCESSING METHOD, ELECTRONIC DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventor: Zimin CHEN, Shenzhen (CN)

(21) Appl. No.: 18/883,648

(22) Filed: Sep. 12, 2024

Related U.S. Application Data
(63) Continuation of application No. PCT/CN2023/123353, filed on Oct. 8, 2023.

(30) Foreign Application Priority Data
Nov. 15, 2022 (CN) 202211426861.7

(51) Int. Cl. G06Q 20/38; G06F 16/13

(52) U.S. Cl. CPC G06Q 20/389; G06F 16/134

(57) ABSTRACT

A blockchain-based data processing method includes: receiving a service-logic-contract calling transaction associated with a first object; acquiring a management contract when a consensus on the service-logic-contract calling transaction is passed, a proxy contract corresponding to each proxy contract address being associated with a service logic contract in the management contract; acquiring, through the management contract, a proxy contract address associated with a first object on-chain address as a target proxy contract address; acquiring a target proxy contract corresponding to the target proxy contract address, and acquiring the service logic contract through the target proxy contract, the service logic contract being associated with the target proxy contract; and executing the service-logic-contract calling transaction through the service logic contract to obtain a transaction execution result, and writing the transaction execution result into the target proxy contract, the transaction execution result in the target proxy contract being associated with the first object.

### CROSS-REFERENCES TO RELATED APPLICATIONS

This application is a continuation application of PCT Patent Application No. PCT/CN2023/123353, filed on Oct. 8, 2023, which claims priority to Chinese Patent Application No. 202211426861.7, filed on Nov. 15, 2022, all of which is incorporated herein by reference in their entirety.

### FIELD OF THE TECHNOLOGY

The present disclosure relates to the field of computer technologies, and in particular, to a blockchain-based data processing method and apparatus, an electronic device, a computer-readable storage medium, and a computer program product.

### BACKGROUND OF THE DISCLOSURE

With the rapid development of network technologies and more emphasis on data security, blockchain has gained great attentions and applications. Therefore, decentralized applications on the blockchain are gradually increasing, and on-chain contract deployments are becoming increasingly frequent.

Currently, service logic contracts are managed on the blockchain through proxy contracts. That is, after a service logic contract is deployed in the blockchain, an address of an on-chain service contract corresponding to the service logic contract is registered in a proxy contract, and then a plurality of service logic contracts is called by the proxy contract, to facilitate the upgrade and storage maintenance of the service logic contract. However, for some service logic contracts having fixed service functions, when different users or different services need to apply these fixed service functions, service logic contracts corresponding to the fixed service functions need to be respectively deployed. Therefore, when a large amount of contract code of the service logic contracts corresponding to the fixed service functions is used, a large cost is required to deploy the service logic contracts each time. In addition, repeated deployments of the service logic contracts with the same code also greatly waste system resources.

### SUMMARY

One embodiment of the present disclosure provides a blockchain-based data processing method performed by a blockchain node. The method includes: receiving a service-logic-contract calling transaction associated with a first object; acquiring a management contract when a consensus on the service-logic-contract calling transaction is passed, the management contract storing one or more proxy contract addresses, each proxy contract address being associated with a different object on-chain address, and a proxy contract corresponding to each proxy contract address being associated with a service logic contract; acquiring, in the one or more proxy contract addresses, a proxy contract address associated with a first object on-chain address corresponding to the first object as a target proxy contract address through the management contract; acquiring a target proxy contract corresponding to the target proxy contract address, and acquiring the service logic contract through the target proxy contract, the service logic contract being associated with the target proxy contract; and executing the service-logic-contract calling transaction through the service logic contract to obtain a transaction execution result, and writing the transaction execution result into the target proxy contract, the transaction execution result in the target proxy contract being associated with the first object.

Another embodiment of the present disclosure provides an electronic device. The electronic device includes one or more processors, a memory, and a network interface, the one or more processors being connected to the memory and the network interface, the network interface being configured to provide a data communication function, and the memory being configured to store computer executable instructions that, when being executed, cause the one or more processors to perform: receiving a service-logic-contract calling transaction associated with a first object; acquiring a management contract when a consensus on the service-logic-contract calling transaction is passed, the management contract storing one or more proxy contract addresses, each proxy contract address being associated with a different object on-chain address, and a proxy contract corresponding to each proxy contract address being associated with a service logic contract; acquiring, in the one or more proxy contract addresses, a proxy contract address associated with a first object on-chain address corresponding to the first object as a target proxy contract address through the management contract; acquiring a target proxy contract corresponding to the target proxy contract address, and acquiring the service logic contract through the target proxy contract, the service logic contract being associated with the target proxy contract; and executing the service-logic-contract calling transaction through the service logic contract to obtain a transaction execution result, and writing the transaction execution result into the target proxy contract, the transaction execution result in the target proxy contract being associated with the first object.

Another embodiment of the present disclosure provides a non-transitory computer-readable storage medium containing computer executable instructions that, when being executed, cause at least one processor to perform: receiving a service-logic-contract calling transaction associated with a first object; acquiring a management contract when a consensus on the service-logic-contract calling transaction is passed, the management contract storing one or more proxy contract addresses, each proxy contract address being associated with a different object on-chain address, and a proxy contract corresponding to each proxy contract address being associated with a service logic contract; acquiring, in the one or more proxy contract addresses, a proxy contract address associated with a first object on-chain address corresponding to the first object as a target proxy contract address through the management contract; acquiring a target proxy contract corresponding to the target proxy contract address, and acquiring the service logic contract through the target proxy contract, the service logic contract being associated with the target proxy contract; and executing the service-logic-contract calling transaction through the service logic contract to obtain a transaction execution result, and writing the transaction execution result into the target proxy contract, the transaction execution result in the target proxy contract being associated with the first object.

### BRIEF DESCRIPTION OF THE DRAWINGS

To describe the technical solutions of the embodiments of the present disclosure or the related art more clearly, the following briefly introduces the accompanying drawings required for describing the embodiments or the related art. Apparently, the accompanying drawings in the following description show only some embodiments of the present disclosure, and a person of ordinary skill in the art may still derive other accompanying drawings from these accompanying drawings without creative efforts.

FIG. 1 is a schematic diagram of a network architecture according to an embodiment of the present disclosure.

FIG. 2a is a schematic diagram of a scenario of proxy contract deployment according to an embodiment of the present disclosure.

FIG. 2b is a schematic diagram of a scenario of service logic contract calling according to an embodiment of the present disclosure.

FIG. 3a is a schematic flowchart of a blockchain-based data processing method according to an embodiment of the present disclosure.

FIG. 3b is a schematic structural diagram of a contract relationship according to an embodiment of the present disclosure.

FIG. 4 is a schematic flowchart of a blockchain-based data processing method according to an embodiment of the present disclosure.

FIG. 5 is a schematic flowchart of contract deployment and calling according to an embodiment of the present disclosure.

FIG. 6 is a schematic structural diagram of a blockchain-based data processing apparatus according to an embodiment of the present disclosure.

FIG. 7 is a schematic structural diagram of an electronic device according to an embodiment of the present disclosure.

### DESCRIPTION OF EMBODIMENTS

The technical solutions in the embodiments of the present disclosure are clearly and completely described below with reference to accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

Embodiments of the present disclosure provide a data processing method and apparatus, an electronic device, a non-transitory computer-readable storage medium, and a computer program product, which can reduce the amount of code required during contract deployment, and further reduce excessive occupancy of network storage resources and reduce waste of system resources.

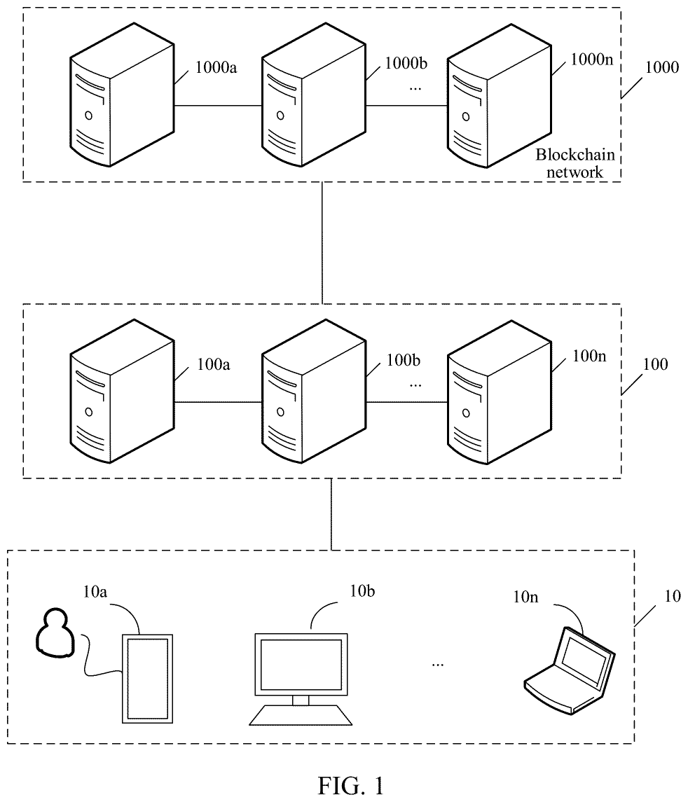

FIG. 1 is a schematic diagram of a network architecture according to an embodiment of the present disclosure. A blockchain is a new application mode of computer technologies such as distributed data storage, point-to-point transmission, a consensus mechanism, and an encryption algorithm, and is mainly configured to organize data in chronological order and encrypt the data into a ledger, so that the data cannot be tampered with and forged. In addition, the data can be verified, stored, and updated. The blockchain is essentially a decentralized database. Each node in the database stores an identical blockchain. A blockchain network can divide nodes into consensus nodes and service nodes, where the consensus nodes are responsible for consensus of an entire blockchain network. A process of writing transaction data into the ledger in the blockchain network may be as follows. A client sends the transaction data to the service node, and then the transaction data is passed between the service nodes in the blockchain network in a form of a baton until the consensus node receives the transaction data. The consensus node packages the transaction data into a block and reaches consensus with other consensus nodes, and after the consensus is passed, the block carrying the transaction data is written into the ledger.

The block is a data packet that carries the transaction data (that is, transaction service) on the blockchain network is a data structure marked with a timestamp and a hash value of a previous block. The block verifies and determines the transaction in the block through a consensus mechanism of the network.

The hash value is alternatively referred to as information feature value or feature value, and the hash value is generated by converting input data of any length into password and outputting it fixedly through a hash algorithm. The original input data cannot be retrieved by decrypting the hash value and is a one-way encryption function. In the blockchain, each block (except an initial block) includes the hash value of the previous block, and the previous block is referred to as a parent block of a current block. The hash value is a potential core foundation and a most important aspect in the blockchain technology, and preserves the authenticity of recording and viewing data and the integrity of the blockchain as a whole.

A blockchain system may include a smart contract. The smart contract in the blockchain system may be understood as a code that can be understood and executed by nodes of the blockchain (including the consensus nodes), which can execute arbitrary logic and obtain a result. A user can initiate a transaction service request through a client, and calls the smart contract that has been deployed on the blockchain. Subsequently, the service node on the blockchain can send the transaction service request to the consensus node, and the consensus nodes on the blockchain can run the smart contract separately. The blockchain may include one or more smart contracts. These smart contracts may be distinguished by an identity document (ID) or a name, and the transaction service request initiated by the client may also carry the identity document or the name of the smart contract to specify the smart contract that the blockchain needs to run. However, when the smart contract specified by the client is a contract that needs to read data, each consensus node accesses a local ledger to read the data. Finally, each consensus node verifies with each other whether the execution results are consistent (that is, consensus is performed). If the execution results are consistent, the execution results may be stored in the respective local ledgers and returned to the client.

As shown in FIG. 1, the network architecture may include a blockchain node cluster 1000, a service server (server) cluster 100, and a terminal (client) cluster 10. The blockchain node cluster 1000 may include at least two blockchain nodes. As shown in FIG. 1, the blockchain node cluster 1000 may include a blockchain node 1000a, a blockchain node 1000b, . . . , and a blockchain node 1000n. The service server cluster 100 may specifically include a service server 100a, a service server 100b, . . . , and a service server 100n. The terminal cluster 10 may specifically include a terminal 10a, a terminal 10b, . . . , and a terminal 10n.

As shown in FIG. 1, the terminal 10a, the terminal 10b, . . . , and the terminal 10n may perform data connection with the service server 100a, the service server 100b, . . . , and the service server 100n respectively, so that the terminal may perform data interaction with the service server through the data connection; the service server 100a, the service server 100b, . . . , and the service server 100n may perform data connection with the blockchain node 1000a, the blockchain node 1000b, . . . , and the blockchain node 1000n respectively, so that the service server may perform data interaction with the blockchain node through the data connection; and the blockchain node 1000a, the blockchain node 1000b, . . . , and the blockchain node 1000n are connected to each other, so that data interaction can be performed between the blockchain nodes.

Data or blocks can be transmitted between the blockchain nodes through the data connection. The blockchain network may realize data connection between the blockchain nodes based on node identifiers. Each blockchain node in the blockchain network has a corresponding node identifier, and each blockchain node can store the node identifiers of other blockchain nodes that are connected to themselves, so that the obtained data or generated blocks are broadcast to other blockchain nodes based on the node identifiers of other blockchain nodes subsequently. For example, the blockchain node 1000a may maintain a node identifier list as shown in Table 1. The node identifier list stores node names and node identifiers of other nodes.

TABLE 1

| Node name | Node identifier |
|---|---|
| Blockchain node 1000a | AAA.AAA.AAA.AAA |
| Blockchain node 1000b | BBB.BBB.BBB.BBB |
| . . . | . . . |
| Blockchain node 1000n | CCC.CCC.CCC.CCC |

The node identifier may be an internet protocol (IP) address and any other type of information that can be used to identify the blockchain node in the blockchain network. Table 1 only uses the IP address as an example for description. For example, the blockchain node 1000a may send information (for example, transaction data) to the blockchain node 1000b through the node identifier BBB.BBB.BBB.BBB, and the blockchain node 1000b may determine that the information is sent by the blockchain node 1000a through the node identifier AAA.AAA.AAA.AAA.

In the blockchain, before a block is added to the chain, the block needs to pass the consensus node in the blockchain network for consensus. The block can be added to the blockchain only after the consensus is passed. When the blockchain is used in some scenarios of governments or commercial institutions, not all participating nodes in the blockchain (that is, the blockchain nodes in the blockchain node cluster 1000) have sufficient resources and necessity to become the consensus nodes of the blockchain. For example, in the blockchain node cluster 1000 shown in FIG. 1, the blockchain node 1000a, the blockchain node 1000b, and the blockchain node 1000n may be used as the consensus nodes in the blockchain node cluster. The consensus nodes in the blockchain node cluster 1000 participate in the consensus, that is, consensus on the block (including a batch of transactions), including generating a block and voting the block; and non-consensus nodes do not participate in the consensus, but help spread the block and a voting message, synchronize status with each other, and the like.

The data connection is not limited to the connection manner, and may be directly or indirectly connected in a wired communication manner, or directly or indirectly connected in a wireless communication manner, or may further be connected in another connection manner. This is not limited in the present disclosure.

The blockchain-based data processing method provided in the embodiments of the present disclosure may be executed by an electronic device, and the electronic device includes but is not limited to the blockchain node (which may a terminal or a server), the service server, and the terminal. The server may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a CDN, big data, and an artificial intelligence platform. The terminal may be a smartphone, a tablet computer, a notebook computer, a desktop computer, a smart speaker, a smartwatch, or the like, but is not limited thereto.

The embodiments of the present disclosure may be applied to various scenarios, including but not limited to, cloud technology, artificial intelligence, intelligent transportation, assisted driving, and the like.

In one embodiment of the present disclosure, related data such as the transaction data are involved. When the foregoing embodiments of the present disclosure are applied to specific products or technologies, permission or consent of the user needs to be obtained, and collection, use, and processing of the relevant data need to comply with relevant laws, regulations, and standards of relevant countries and regions.

As shown in FIG. 1, each terminal in the terminal cluster may be mounted with an application client. When the application client is run in each terminal, the application client may perform data interaction with any service server in the service server cluster 100, so that any service server in the service server cluster 100 may receive service data from each terminal. The application client may be application clients with data information functions of displaying text, images, audio, and videos such as a game application, a video editing application, a social application, an instant messaging application, a live streaming application, a short video application, a video application, a music application, a shopping application, a novel application, a payment application, or a browser. The application client may be an independent client or an embedded sub-client integrated in a client (for example, an instant messaging client, a social client, and a video client). This is not limited herein.

A first object may perform data interaction with the blockchain through an application client running in a terminal associated with the first object, to use a service function provided by a service logic contract in the blockchain. For example, the first object wants to apply to acquire a smart wallet through the application client. The smart wallet may help the first object manage digital assets in the blockchain. The digital assets refer to new intangible assets released, registered, stored, owned, transferred, or transacted based on the blockchain technology. These intangible assets exist in a digitized form in a specific system as digital identifiers of value or rights. Assuming that all functions of the smart wallet are implemented by the service logic contract in the blockchain, when the first object applies to acquire the smart wallet, the terminal generates a wallet acquisition request in response to the application operation, and then sends the wallet acquisition request to the service server. The service server may generate a proxy contract deployment transaction based on the wallet acquisition request, and then send the proxy contract deployment transaction to the blockchain node. The proxy contract deployment transaction is configured for deploying a proxy contract (which may be referred to as a target proxy contract) for the first object in the blockchain. Then, when the first object wants to use a function in the smart wallet, the service logic contract may be called through the target proxy contract, and related data generated by calling the service logic contract is also stored in the target proxy contract. After the proxy contract deployment transaction reaches consensus, the blockchain node deploys a target proxy contract associated with the service logic contract for the first object, and writes the target proxy contract and a first object on-chain address corresponding to the first object into a management contract, correlatively. The management contract is configured for managing a proxy contract address corresponding to a proxy contract associated with the service logic contract, and each proxy contract address stored in the management contract is associated with a different object on-chain address. Then, the blockchain node notifies the service server of the successful deployment of the proxy contract, and the service server may notify the terminal of the successful acquisition of the smart wallet. Then, the first object can use the smart wallet.

When the first object wants to use a function of the smart wallet, the terminal may generate a wallet use request in response to a wallet use operation of the first object, and then send the wallet use request to the service server. The service server may generate a service-logic-contract calling transaction based on the wallet use request, and then send the service-logic-contract calling transaction to the blockchain node. After receiving the service-logic-contract calling transaction associated with the first object, the blockchain node acquires the management contract when a consensus on the service-logic-contract calling transaction is passed, and then acquires, in the one or more proxy contract addresses stored, a proxy contract address associated with the first object on-chain address corresponding to the first object as a target proxy contract address through the management contract. Then, the blockchain node acquires a target proxy contract corresponding to the target proxy contract address, acquires the service logic contract through the target proxy contract, executes the service-logic-contract calling transaction through the service logic contract, to obtain a transaction execution result, and writes the transaction execution result into the target proxy contract. The transaction execution result in the target proxy contract is associated with the first object. Finally, the blockchain node may return the transaction execution result to the service server, and then the service server sends the transaction execution result to the terminal.

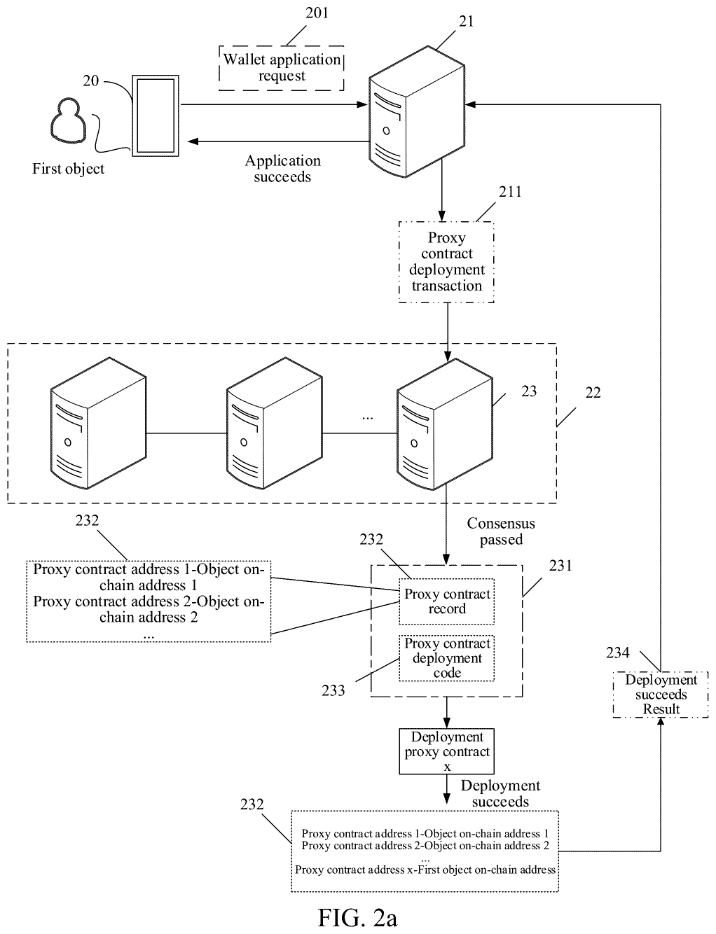

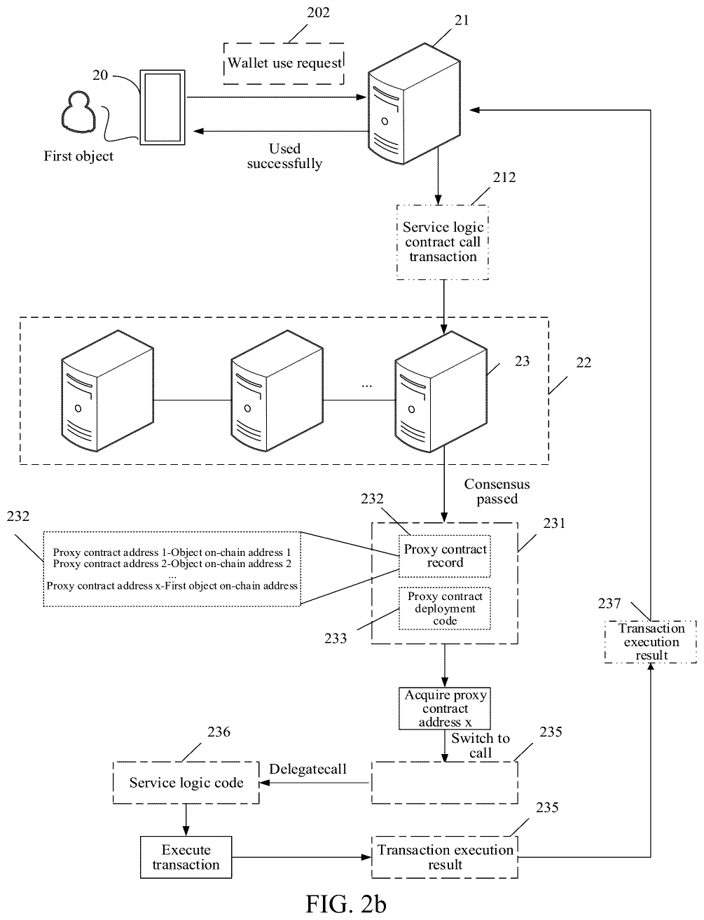

For case of understanding the foregoing process, referring to FIG. 2a to FIG. 2b together, the terminal 20 shown in FIG. 2a to FIG. 2b may be any terminal in the terminal cluster 10 shown in FIG. 1, for example, the terminal 20 may be the terminal 10a; the service server 21 shown in FIG. 2a to FIG. 2b may be any service server in the service server cluster 100 shown in FIG. 1, for example, the service server 21 may be the service server 100b; and the blockchain network 22 shown in FIG. 2a to FIG. 2b may be a blockchain network including the blockchain node cluster 1000 shown in FIG. 1, and the blockchain node 23 in the blockchain network 22 may be any blockchain node in the blockchain node cluster 1000 shown in FIG. 1, for example, the blockchain node 23 is the blockchain node 1000a.

FIG. 2a is a schematic diagram of a scenario of proxy contract deployment according to an embodiment of the present disclosure. The terminal 20 has an association relationship with the first object. The application client is installed in the terminal 20. All ordinary objects having a permission to log in to the application client can apply, through the application client, to use a service function provided by the service logic contract in the blockchain network. For example, the first object may acquire a smart wallet belonging only to the first object through the application client, and a corresponding function of the smart wallet is implemented by the service logic contract in the blockchain network. When applying for the smart wallet, the first object needs to first apply, through the application client, to deploy the proxy contract associated with the first object in the blockchain network. Then, during use of the smart wallet by the first object, the blockchain node delegate calls the service logic contract through the proxy contract, and records contract execution data in the proxy contract. Because the first object needs to store the contract execution data generated each time the service logic contract is called during use of the smart wallet, the first object can directly acquire related data when using the smart wallet next time. For example, when the first object transfers a number of 100 digital assets to the smart wallet, the smart wallet needs to record a current number of balances of the first object as 100, so that the current number of balances of the first object can be directly determined when the first object makes a transfer next time using the smart wallet. If the contract execution data is directly stored in the service logic contract, another object cannot use the service logic contract. Therefore, the contract execution data generated during calling of the service logic contract can be stored through the proxy contract.

As shown in FIG. 2a, the first object performs a smart wallet acquisition operation through the terminal 20. The terminal 20 generates a wallet application request 201 in response to the smart wallet acquisition operation. Then, the terminal 20 sends the wallet application request 201 to a service server 21. The service server 21 may generate, based on the wallet application request 201, a proxy contract deployment transaction 211 for a service logic contract associated with the smart wallet, and then send the proxy contract deployment transaction 211 to any blockchain node, for example, the blockchain node 23, in the blockchain network 22. After receiving the proxy contract deployment transaction 211, the blockchain node 23 acquires a management contract 231 for the service logic contract when it is determined that a consensus on the proxy contract deployment transaction 211 is passed. The management contract may include a proxy contract record 232 and proxy contract deployment code 233. The proxy contract record 232 is configured for storing a proxy contract address of a created proxy contract and an object on-chain address associated with the proxy contract address. For example, the proxy contract record 232 stores a proxy contract address 1 and an object on-chain address 1, and a proxy contract address 2 and an object on-chain address 2, correlatively. The proxy contract deployment code 233 is configured for deploying the proxy contract. The blockchain node 23 may deploy, through the proxy contract deployment code 233, a proxy contract associated with the first object, which is assumed to be a proxy contract x. After the proxy contract x is successfully deployed, the blockchain node 23 also writes a proxy contract address x corresponding to the proxy contract x and the first object on-chain address corresponding to the first object into the proxy contract record 232. Then, the blockchain node 23 sends a deployment success result 234 to the service server 21. Then, the service server 21 notifies the terminal 20 of the successful application of the smart wallet.

Further, FIG. 2b is a schematic diagram of a scenario of service logic contract calling according to an embodiment of the present disclosure. As shown in FIG. 2b, after acquiring the smart wallet, the first object may perform a smart wallet use operation through the terminal 20. The terminal 20 generates a wallet use request 202 in response to the smart wallet use operation. Then, the terminal 20 sends the wallet use request 202 to the service server 21. The service server 21 may generate a service-logic-contract calling transaction 212 based on the wallet use request 202, and then send the service-logic-contract calling transaction 212 to any blockchain node, for example, the blockchain node 23, in the blockchain network 22. After receiving the service-logic-contract calling transaction 212, the blockchain node 23 acquires the management contract 231 for the service logic contract when it is determined that a consensus on the service-logic-contract calling transaction 212 is passed, and then searches the management contract 231 for the proxy contract address associated with the first object on-chain address, that is, acquiring the proxy contract address x. Then, the blockchain node 23 may switch to call a proxy contract 235 (that is, the proxy contract x in FIG. 2a) based on the proxy contract address x. Then, the blockchain node 23 may delegatecall a service logic contract 236 through the proxy contract 235, execute a transaction based on service logic code in the delegatecalled service logic contract 236, to obtain a transaction execution result of the service-logic-contract calling transaction 212, and write the transaction execution result into the proxy contract 235. Then, the transaction execution result 237 is sent to the service server 21. Then, the service server 21 notifies the terminal 20 of the successful use of the smart wallet.

In this way, when the first object needs to apply a related function provided by the service logic contract, the service logic contract may be called through the proxy contract and a related transaction execution result is stored. Therefore, the first object does not need to deploy a service logic contract with a more complex function and a larger amount of code on the blockchain in advance, but only deploys a proxy contract with a small amount of code on the blockchain in advance. The amount of code that needs to be deployed is reduced, which can indirectly reduce consumption costs during contract deployment.

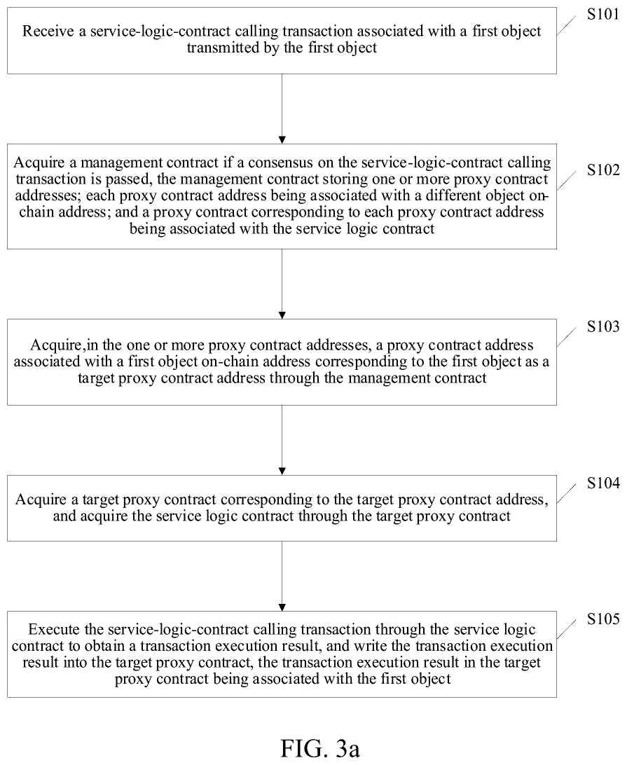

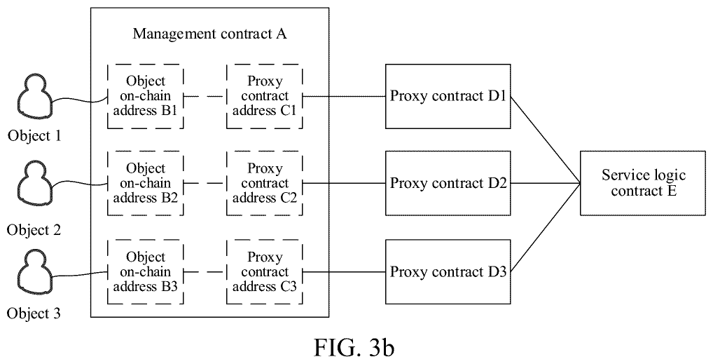

Further, FIG. 3a is a schematic flowchart of a blockchain-based data processing method according to an embodiment of the present disclosure. The method may be performed by a blockchain node (for example, any blockchain node in the blockchain node cluster 1000 in the embodiment corresponding to FIG. 1). The following uses an example in which the method is performed by a blockchain node. The blockchain-based data processing method may include at least the following operation S101 to operation S105.

Operation S101: Receive a service-logic-contract calling transaction associated with a first object.

For example, the service-logic-contract calling transaction refers to a transaction that requires calling of a service logic contract during execution. The service logic contract may be any smart contract deployed in the blockchain.

For example, the service-logic-contract calling transaction associated with the first object refers to a service-logic-contract calling transaction generated by signing with a private key of the first object. The service-logic-contract calling transaction received by the blockchain node may be sent by the service server. That is, after receiving a service logic contract calling request sent by the terminal, the service server may acquire the private key of the first object from storage, sign the service logic contract calling request with the private key of the first object to obtain the service-logic-contract calling transaction, and then send the service-logic-contract calling transaction to the blockchain node. The service logic contract calling request may be generated by the terminal in response to a service logic contract calling operation of the first object. The service server needs to be authorized by the first object before storing the private key of the first object.

The blockchain node may acquire a public key of the first object, and verify signature data associated with the service-logic-contract calling transaction. If the verification succeeds, the blockchain node may send the service-logic-contract calling transaction to the consensus network in the blockchain network for consensus.

Operation S102: Acquire a management contract when a consensus on the service-logic-contract calling transaction is passed, the management contract storing one or more proxy contract addresses; each proxy contract address being associated with a different object on-chain address; and a proxy contract corresponding to each proxy contract address being associated with a service logic contract.

For example, the proxy contract address refers to a unique address of a proxy contract in the blockchain network, and different proxy contracts correspond to different proxy contract addresses. The object on-chain address refers to a unique address generated in the blockchain network based on a pair of public and private keys bound to the object, and is also a unique address configured for identifying the object on the blockchain.

For example, the management contract is a smart contract configured for managing the proxy contract. The management contract stores one or more proxy contract addresses and an object on-chain address associated with each proxy contract address, to facilitate the blockchain node to quickly acquire proxy contracts associated with different objects. The proxy contract is a smart contract configured for delegatecalling the service logic contract and storing related data generated by executing the service logic contract. One proxy contract is associated with only one object, and data stored in the proxy contract is related to the object to which the proxy contract is associated, and is not related to another object.

Further, for case of understanding, referring to FIG. 3b together, FIG. 3b is a schematic structural diagram of a contract relationship according to an embodiment of the present disclosure. As shown in FIG. 3b, a proxy contract D1, a proxy contract D2, and a proxy contract D3 are associated with a management contract A. The proxy contract D1, the proxy contract D2, and the proxy contract D3 can all call the same service logic contract E. Because one proxy contract is associated with only one object, when an object 1 is associated with a proxy contract 1 deployed in the blockchain network, the blockchain node may store, in the management contract A, an object on-chain address B1 corresponding to the object 1 and a proxy contract address C1 corresponding to the proxy contract D1, correlatively. When an object 2 is associated with a proxy contract 2 deployed in the blockchain network, the blockchain node may store, in the management contract A, an object on-chain address B2 corresponding to the object 2 and a proxy contract address C2 corresponding to the proxy contract D2, correlatively. When an object 3 is associated with a proxy contract 3 deployed in the blockchain network, the blockchain node may store, in the management contract A, an object on-chain address B3 corresponding to the object 2 and a proxy contract address C3 corresponding to the proxy contract D3, correlatively. Through the contract relationship shown in FIG. 3b, when transactions sent by different objects need to call the service logic contract E, the blockchain node calls the service logic contract E only through the proxy contract associated with the blockchain node, and stores related data in the proxy contract associated with the object, thereby avoiding confusion of sending data of different objects.

Operation S103: Acquire, in the one or more proxy contract addresses, a proxy contract address associated with a first object on-chain address corresponding to the first object as a target proxy contract address through the management contract.

For example, the blockchain node may acquire the object on-chain address corresponding to the first object based on the service-logic-contract calling transaction. Then, the blockchain node may acquire the target proxy contract address in the management contract based on the first object on-chain address. For example, still referring to FIG. 3b, it is assumed that when the first object is the object 2, and the first object on-chain address is the object on-chain address B2, the target proxy contract is the proxy contract D2.

In some embodiments, the blockchain node first searches the one or more proxy contract addresses in the management contract based on the first object on-chain address corresponding to the first object; and when finding a proxy contract address associated with the first object on-chain address corresponding to the first object in the one or more proxy contract addresses, performs the following operations: acquiring, in the one or more proxy contract addresses, the proxy contract address associated with the first object on-chain address corresponding to the first object as the target proxy contract address through the management contract; and transmitting proxy contract registration guidance information to the first object when not finding the proxy contract address associated with the first object on-chain address corresponding to the first object in the one or more proxy contract addresses. The proxy contract registration guidance information is configured for guiding the first object to initiate deployment of the proxy contract associated with the first object in the blockchain network.

Operation S104: Acquire a target proxy contract corresponding to the target proxy contract address, and acquire the service logic contract through the target proxy contract.

For example, the blockchain node may acquire the target proxy contract associated with the first object through the target proxy contract address, and then the blockchain node calls the service logic contract through the target proxy contract to execute the service-logic-contract calling transaction.

In some embodiments, the acquiring a target proxy contract corresponding to the target proxy contract address, and acquiring the service logic contract through the target proxy contract in operation 104 may be implemented through the following technical solutions: switching, in a first context, the first context to a second context in a process of switching to call a target proxy contract corresponding to the target proxy contract address through the management contract. The first context is a context corresponding to the management contract; and the second context is a context corresponding to the target proxy contract. The service logic contract is delegatecalled through the target proxy contract in the second context; and the second context remains unchanged when delegatecalling the service logic contract. The switching to call the target proxy contract corresponding to the target proxy contract address through the management contract may be implemented through a call instruction. The delegate calling the service logic contract by the target proxy contract may be implemented by a delegatecall instruction. Both the call instruction and the delegatecall instruction are instruction functions that implement a cross-contract function calling function in a high-level programming language Solidity (a high-level programming language created for implementing smart contracts that is contract-oriented). When the call instruction is used to switch to call the contract, a calling manner of the call changes a context of the contract and a value of an address (msg.sender) initiated by calling a built-in variable of Solidity, that is, the msg.sender is modified to a caller, that is, an address of a current caller of a call stack, and an execution environment is modified to a runtime environment of a callee, that is, storage of the contract. However, delegatecall is simply to “delegate” the callee to manage a context (that is, storage) of the callee. When the delegatecall instruction is used to delegate call the contract, the execution environment is still modified to a runtime environment of the caller, that is, storage of the contract, and msg.sender is an initial address of a call stack. For example, A calls B, and then B delegatecalls C. msg.sender that B calls C during delegatecall is A. In this case, the context is a context of B, but if it is call, msg.sender is B and the context is a context of B.

Operation S105: Execute the service-logic-contract calling transaction through the service logic contract to obtain a transaction execution result, and write the transaction execution result into the target proxy contract. The transaction execution result in the target proxy contract is associated with the first object.

In some embodiments, an exemplary process of executing the service-logic-contract calling transaction through the service logic contract to obtain a transaction execution result, and write the transaction execution result into the target proxy contract may be as follows: executing the service-logic-contract calling transaction through the service logic contract in the second context, to obtain the transaction execution result; and writing the transaction execution result into the second context corresponding to the target proxy contract.

In some embodiments, the service-logic-contract calling transaction may include transaction data and a to-be-called function name, where the to-be-called function name represents a name of a function that needs to be called in the service logic contract and that is configured for executing the transaction data. In the second context, an exemplary process of executing the service-logic-contract calling transaction through the service logic contract to obtain the transaction execution result may be implemented through the following technical solutions: acquiring a to-be-called function in the service logic contract based on the to-be-called function name; acquiring historical transaction data for the transaction data in the second context based on the to-be-called function; and executing the to-be-called function based on the transaction data and the historical transaction data, to obtain the transaction execution result. In the second context, the acquiring historical transaction data for the transaction data may be acquiring the historical transaction data for the transaction data in the storage of the target proxy contract. For ease of understanding, it is assumed that the service-logic-contract calling transaction is generated when the object 1 wants to transfer 100 tokens to the object 2. When one token may represent one digital asset in the blockchain, transaction data included in the token may be 100, and a to-be-called function name may be “transfer”, and a to-be-called function corresponding to the “transfer” is a transfer function in the service logic contract. In this case, after switching to call the target proxy contract through the management contract, the blockchain node may delegatecall the service logic contract through the target proxy contract, and then acquire the transfer function. Assuming that when a number of assets of the object 1 in the target proxy contract is 500, the number of assets of the object 1 that are acquired by the blockchain node based on the transfer function is 500. Then, the blockchain node executes the transfer function, and the number of assets of the object 1 changes to 500-100-400. Then, the blockchain node updates the number of assets of the object 1 in the target proxy contract. In short, when the target proxy contract delegatecalls the service logic contract, execution logic of the transaction is determined by a function in the service logic contract, but historical transaction data required during transaction execution is acquired from the storage of the target proxy contract, and the data after transaction execution is also updated and modified in the storage of the target proxy contract.

According to the method provided in the embodiments of the present disclosure, when the first object needs to apply a related function provided by the service logic contract, the service logic contract may be called through the proxy contract and a related transaction execution result is stored. Therefore, the first object does not need to deploy a service logic contract with a more complex function and a larger amount of code on the blockchain in advance, but only deploys a proxy contract with a small amount of code on the blockchain in advance. The amount of code that needs to be deployed is reduced, which can indirectly reduce consumption costs during contract deployment. In addition, the blockchain system no longer needs to store and maintain a plurality of service logic contracts with a large amount of complex code, but only needs to store one service logic contract with a large amount of complex code and maintain a plurality of proxy contracts with a small amount of code, which can reduce waste of system resources on the blockchain.

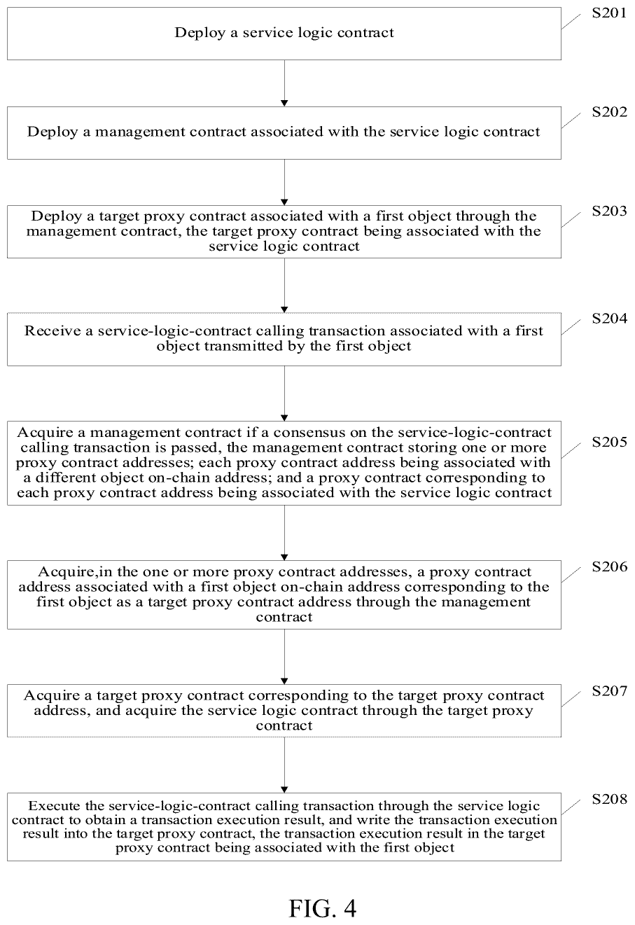

Further, FIG. 4 is a schematic flowchart of a blockchain-based data processing method according to an embodiment of the present disclosure. The method may be performed by a blockchain node (for example, any blockchain node in the blockchain node cluster 1000 in the embodiment corresponding to FIG. 1). The following uses an example in which the method is performed by a blockchain node. The blockchain-based data processing method may include at least the following operation S201 to operation S208.

Operation S201: Deploy a service logic contract.

For example, still referring to the schematic structural diagram of the contract relationship shown in FIG. 3b, a plurality of proxy contracts is associated with the same service logic contract, which means that the plurality of proxy contracts reuses the same service logic contract. However, the service logic contract needs to be a smart contract deployed in the blockchain network. Therefore, when the contract relationship shown in FIG. 3b is constructed, the service logic contract needs to be first deployed in the blockchain network.

In some embodiments, the deploying a service logic contract in operation 201 may be implemented through the following technical solutions: The blockchain node may receive a service-logic-contract deployment transaction associated with the management object, where the service-logic-contract deployment transaction includes service logic contract code. When a consensus on the service-logic-contract deployment transaction is passed, the service logic contract is deployed by executing the service logic contract code. When the service logic contract is successfully deployed, a service logic contract address corresponding to the service logic contract is transmitted to the management object. The service-logic-contract deployment transaction associated with the management object is a transaction generated after the service server receives a service logic contract deployment request initiated by the management object and signs the service logic contract deployment request with a private key associated with the management object. The service-logic-contract deployment transaction carries the service logic code of the service logic contract.

Operation S202: Deploy a management contract associated with the service logic contract.

For example, for a deployed service logic contract, to facilitate management of a plurality of proxy contracts associated with the service logic contract and deployed in the blockchain network subsequently, one management contract associated with only the service logic contract may be deployed first before the proxy contracts associated with the service logic contract are deployed in the blockchain network. The management contract may include a service logic contract address and service code corresponding to the proxy contract. The service logic contract address is configured for acquiring the service logic contract by the blockchain node. The service code corresponding to the proxy contract is configured for deploying a new proxy contract in the blockchain network by the blockchain node. In other words, when a target object wants to deploy a new proxy contract, the blockchain node may deploy a corresponding proxy contract for the target object through the service code corresponding to the proxy contract stored in the management contract. In addition, the blockchain node may alternatively write, in the management contract, an object on-chain address of the target object and a proxy contract address of the proxy contract corresponding to the target object into the management contract, correlatively. Then, when receiving a service-logic-contract calling transaction that the target object wants to call the service logic contract, the blockchain node may acquire the proxy contract corresponding to the target object through the management contract, delegatecall the service logic contract through the proxy contract corresponding to the target object, and write a transaction execution result corresponding to the service-logic-contract calling transaction into the proxy contract corresponding to the target object for storage.

In some embodiments, the deploying a management contract associated with the service logic contract in operation 202 may be implemented through the following technical solutions: The blockchain node may receive a management contract deployment transaction associated with the management object. The management contract deployment transaction may include management contract code, proxy contract deployment code, and a service logic contract address. When a consensus on the management contract deployment transaction is passed, an initial management contract is created by executing the management contract code, and then the proxy contract deployment code and the service logic contract address are written into the initial management contract to obtain the management contract. The proxy contract deployment code is the service code corresponding to the proxy contract.

For example, an exemplary process of deploying the management contract associated with the service logic contract may be as follows: The blockchain node may receive a management contract direct deployment transaction associated with the management object. The management contract direct deployment transaction may include management contract direct deployment code. The management contract direct deployment code may include proxy contract deployment code and the service logic contract address. When the consensus on the management contract deployment transaction is passed, the management contract is deployed by executing the management contract direct deployment code. In other words, the management object may hardcode the proxy contract deployment code and the service logic contract address into the management contract code to obtain the management contract direct deployment code. In this way, the management contract obtained by executing the management contract direct deployment code by the blockchain node includes the proxy contract deployment code and the service logic contract address.

In some embodiments, the blockchain node may send a management contract address corresponding to the management contract to the service server. The service server stores the management contract address. When receiving the proxy contract deployment request for the service logic contract associated with the first object, the service server may generate a proxy contract deployment transaction carrying the management contract address. The proxy contract deployment transaction is configured for deploying the target proxy contract for the first object.

In some embodiments, when receiving the management contract deployment transaction associated with the management object, the blockchain node may first acquire a management object on-chain address corresponding to the management object; transmit permission error prompt information to the management object when it is determined that the management object on-chain address does not have a management contract deployment permission; initiate a consensus request for the management contract deployment transaction to the consensus network when it is determined that the management object on-chain address has the management contract deployment permission, so that the consensus network performs consensus processing on the management contract deployment transaction to obtain a consensus result; and determine that the consensus on the management contract deployment transaction is passed when the consensus result is a consensus passing result.

Operation S203: Deploy a target proxy contract associated with a first object through the management contract. The target proxy contract is associated with the service logic contract.

In some embodiments, the blockchain node may receive a proxy contract deployment transaction associated with the first object, where the proxy contract deployment transaction includes a management contract address; acquire a management contract indicated by the management contract address when a consensus on the proxy contract deployment transaction is passed; deploy a target proxy contract associated with the service logic contract through the management contract; and write a proxy contract address corresponding to the target proxy contract and the first object on-chain address corresponding to the first object into the management contract, correlatively.

For example, the management contract includes proxy contract deployment code and a service logic contract address corresponding to the service logic contract. Therefore, an exemplary process of deploying a target proxy contract associated with the service logic contract through the management contract may be implemented through the following technical solutions: creating an initial proxy contract by executing the proxy contract deployment code; and writing the service logic contract address into the initial proxy contract to obtain the target proxy contract associated with the service logic contract.

Operation S204: Receive a service-logic-contract calling transaction associated with the first object.

Operation S205: Acquire the management contract when a consensus on the service-logic-contract calling transaction is passed. The management contract stores one or more proxy contract addresses; each proxy contract address is associated with a different object on-chain address; and a proxy contract corresponding to each proxy contract address is associated with the service logic contract.

Operation S206: Acquire, in the one or more proxy contract addresses, a proxy contract address associated with a first object on-chain address corresponding to the first object as a target proxy contract address through the management contract.

Operation S207: Acquire a target proxy contract corresponding to the target proxy contract address, and acquire the service logic contract through the target proxy contract.

Operation S208: Execute the service-logic-contract calling transaction through the service logic contract to obtain a transaction execution result, and write the transaction execution result into the target proxy contract. The transaction execution result in the target proxy contract is associated with the first object.

For example, for implementation processes of operation S204 to operation S208, reference may be made to the implementation processes of operation S101 to operation S105 in the foregoing embodiment corresponding to FIG. 3a, and details are not described herein again.

By using the method provided in the embodiments of the present disclosure, a minimized proxy contract is deployed to avoid deployment of the service logic contract, reducing costs required to run all transactions and contract execution on the blockchain network, and achieving minimized contract deployment.

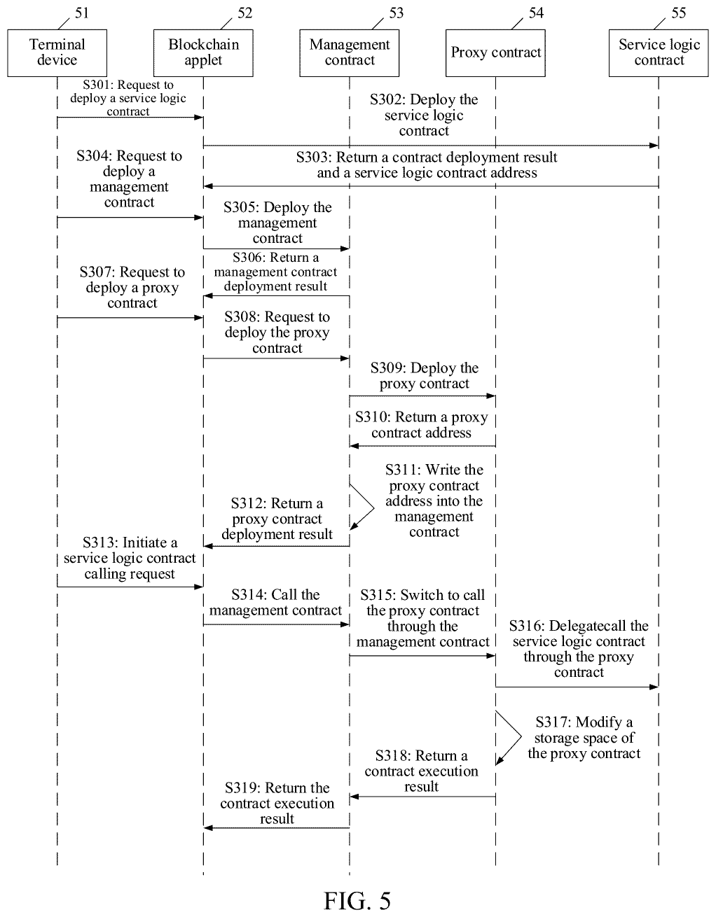

Further, for case of understanding, referring to FIG. 5 together, FIG. 5 is a schematic flowchart of contract deployment and calling according to an embodiment of the present disclosure. As shown in FIG. 5, an entire process involves a terminal 51, a blockchain applet 52, a management contract 53, a proxy contract 54, and a service logic contract 55. The terminal 51 may be any terminal in the terminal cluster 10 shown in FIG. 1, for example, the terminal 51 may be the terminal 10a. The blockchain applet 52 may be an applet, a native application (App) or a Hyper Text Markup Language 5 (H5) page. A client/server (C/S) mode or a browser/server (B/S) mode may be used on a deployment architecture. For example, the blockchain applet 52 may be deployed in the terminal 51, and a server corresponding to the blockchain applet 52 may be deployed in a service server (that is, any service server in the service server cluster 100 shown in FIG. 1, for example, the service server 100a). The management contract 53, the proxy contract 54, and the service logic contract 55 may all be smart contracts deployed in the blockchain network. That is, the management contract 53, the proxy contract 54, and the service logic contract 55 may be deployed in any blockchain node in the blockchain network (which may be any blockchain node in the blockchain network 1000 shown in FIG. 1, for example, the blockchain node 1000a). Data interaction between the blockchain applet 52 and the management contract 53, and between the proxy contract 54 and the service logic contract 55 may be implemented through communication between the service server corresponding to the blockchain applet 52 and the blockchain node in which the management contract 53, the proxy contract 54, and the service logic contract 55 are deployed.

As shown in FIG. 5, an entire process of contract deployment and calling includes the following operations:

Operation S301: The terminal 51 calls the blockchain applet 52 in response to a service logic contract deployment operation.

For example, the terminal 51 may respond to a service logic contract deployment operation of a first object. The first object refers to an object that is currently logged in to the blockchain applet 52 through the terminal 51.

Operation S302: The blockchain applet 52 requests a blockchain node to deploy a service logic contract 55.

For example, the blockchain applet 52 may sign the service logic contract deployment request through a private key of the first object to obtain a service-logic-contract deployment transaction, and then send the service-logic-contract deployment transaction to the blockchain node to request the blockchain node to deploy the service logic contract 55 in the blockchain network. The service logic contract deployment request includes service code corresponding to the service logic contract. To avoid a waste of resources caused by all objects applying to deploy the service logic contract in the blockchain network, the blockchain applet 52 may first verify an object permission of the first object before generating the service-logic-contract deployment transaction, and generate the service-logic-contract deployment transaction when the first object has an administrator permission. When the first object does not have the administrator permission, the service logic contract deployment request is rejected.

Operation S303: After deploying the service logic contract 55, the blockchain node returns a service logic contract deployment result and a service logic contract address to the blockchain applet 52.

For example, for a process of deploying the service logic contract 55, reference may be made to the implementation process of operation S201 in the foregoing embodiment corresponding to FIG. 4, and details are not described herein again.

Operation S304: The terminal 51 calls the blockchain applet 52 in response to a management contract deployment operation.

For example, the terminal 51 may respond to a management contract deployment operation of the first object.

Operation S305: The blockchain applet 52 requests the blockchain node to deploy a management contract 53.

For example, the blockchain applet 52 may sign the management contract deployment request through the private key of the first object to obtain a management contract deployment transaction, and then send the management contract deployment transaction to the blockchain node to request the blockchain node to deploy the management contract 53 in the blockchain network. The management contract deployment request includes service code corresponding to the management contract. The service code corresponding to the management contract may include a service logic contract address and service code corresponding to the proxy contract. To avoid a waste of resources caused by all objects applying to deploy the management contract in the blockchain network, the blockchain applet 52 may first verify the object permission of the first object before generating the management contract deployment transaction, and generate the management contract deployment transaction when the first object has the administrator permission. When the first object does not have the administrator permission, the management contract deployment request is rejected.

Operation S306: After deploying the management contract 53, the blockchain node returns a management contract deployment result and a management contract address to the blockchain applet 52.

For example, for a process of deploying the management contract 53, reference may be made to the description of operation S202 in the foregoing embodiment corresponding to FIG. 4, and details are not described herein again.

Operation S307: The terminal 51 calls the blockchain applet 52 in response to a proxy contract deployment operation.

For example, the terminal 51 may respond to a proxy contract deployment operation of the first object.

Operation S308: The blockchain applet 52 requests the blockchain node to deploy a proxy contract 54.

For example, the blockchain applet 52 may sign the proxy contract deployment request through the private key of the first object to obtain a proxy contract deployment transaction. The proxy contract deployment request includes a management contract address. The proxy contract is usually deployed for all ordinary objects that have a permission to log in to the blockchain applet 52. The blockchain applet 52 only needs to verify whether the first object has a login permission, without adding verification of another permission. In addition, because the management contract 53 already includes the service code corresponding to the proxy contract, the proxy contract deployment request only needs to carry the management contract address. Then, the blockchain applet 52 may send the proxy contract deployment transaction to the blockchain node, to request the blockchain node to deploy the proxy contract 54 in the blockchain network through the management contract 53.

Operation S309: The blockchain node deploys the proxy contract 54 through the management contract 53.

Operation S310: The blockchain node acquires a proxy contract address after deploying the proxy contract 54.

Operation S311: The blockchain node writes the proxy contract address and a first object address into the management contract 53, correlatively.

For example, for implementation processes of operation S309 to operation S311, reference may be made to the implementation process of operation S203 in the foregoing embodiment corresponding to FIG. 4, and details are not described herein again.

Operation S312: The blockchain node returns a proxy contract deployment result to the blockchain applet 52.

Operation S313: The terminal 51 initiates a service logic contract calling request through the blockchain applet 52 in response to a service logic contract calling operation.

Operation S314: The blockchain applet 52 requests, based on the service logic contract calling request, to call the management contract 53 from the blockchain node.

Operation S315: The blockchain node switches to call the proxy contract 54 through the management contract 53.

Operation S316: The blockchain node delegatecalls the service logic contract 55 through the proxy contract 54.

Operation S317: The blockchain node executes the service logic contract 55, and modifies a storage space of the proxy contract 54 based on a contract execution result.

Operation S318: The blockchain node returns the contract execution result to the management contract 53.

Operation S319: The blockchain node returns the contract execution result to the blockchain applet 52 through the management contract 53.

For example, for implementation processes of operation S313 to operation S319, reference may be made to the description of operation S101 to operation S105 in the foregoing embodiment corresponding to FIG. 3a, and details are not described herein again.

Another terminal or another object may also initiate requests such as a proxy contract deployment request and a service logic contract calling request to the blockchain node through the blockchain applet 52.

By using the method provided in the embodiments of the present disclosure, different objects may call the management contract to complete deployment of the proxy contract. A plurality of proxy contracts reuses the same service logic contract, thereby avoiding on-chain deployment of service logic contracts of large files, and reducing costs that need to be paid to run all transactions and contract execution on the blockchain network.

In the embodiments of the present disclosure, related data such as transaction data and contract data are involved. When the embodiments of the present disclosure are applied to specific products or technologies, permission or consent of the user needs to be obtained, and collection, use, and processing of the relevant data need to comply with relevant laws, regulations, and standards of relevant countries and regions.

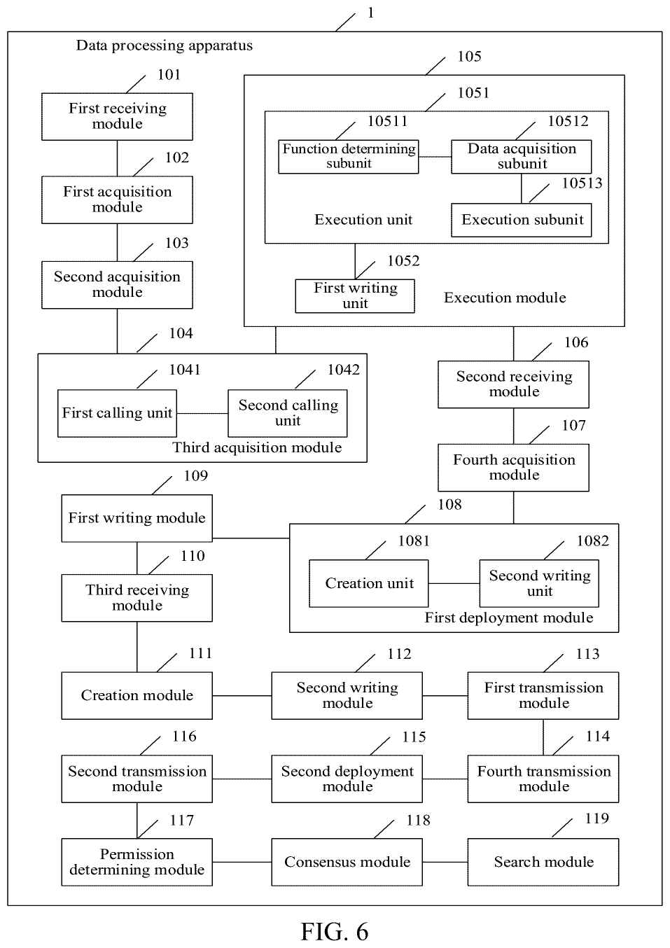

FIG. 6 is a schematic structural diagram of a blockchain-based data processing apparatus according to an embodiment of the present disclosure. The data processing apparatus may be a computer program product (including computer executable instructions) running on an electronic device, for example, the data processing apparatus may be an application software; and the apparatus may be configured to perform corresponding operations in the data processing method provided in the embodiments of the present disclosure. As shown in FIG. 6, the data processing apparatus 1 may include: a first receiving module 101, a first acquisition module 102, a second acquisition module 103, a third acquisition module 104, and an execution module 105. The first receiving module 101 is configured to receive a service-logic-contract calling transaction associated with a first object. The first acquisition module 102 is configured to acquire a management contract when a consensus on the service-logic-contract calling transaction is passed, the management contract storing one or more proxy contract addresses; each proxy contract address being associated with a different object on-chain address; and a proxy contract corresponding to each proxy contract address being associated with a service logic contract. The second acquisition module 103 is configured to acquire, in the one or more proxy contract addresses, a proxy contract address associated with a first object on-chain address corresponding to the first object as a target proxy contract address through the management contract. The third acquisition module 104 is configured to acquire a target proxy contract corresponding to the target proxy contract address, and acquire the service logic contract through the target proxy contract, the service logic contract being associated with the target proxy contract. The execution module 105 is configured to execute the service-logic-contract calling transaction through the service logic contract to obtain a transaction execution result, and write the transaction execution result into the target proxy contract, the transaction execution result in the target proxy contract being associated with the first object.

For specific implementations of the first receiving module 101, the first acquisition module 102, the second acquisition module 103, the third acquisition module 104, and the execution module 105, reference may be made to the description of operation S101 to operation S105 in the foregoing embodiment corresponding to FIG. 3a, and details are not described herein again.

In some embodiments, the third acquisition module 104 includes: a first calling unit 1041 and a second calling unit 1042. The first calling unit 1041 is configured to switch, in a first context, the first context to a second context in a process of switching to call a target proxy contract corresponding to the target proxy contract address through the management contract, where the first context is a context corresponding to the management contract; and the second context is a context corresponding to the target proxy contract. The second calling unit 1042 is configured to delegatecall the service logic contract through the target proxy contract in the second context, where the second context remains unchanged in the process of delegatecalling the service logic contract.

For specific implementations of the first calling unit 1041 and the second calling unit 1042, reference may be made to the description of operation S104 in the foregoing embodiment corresponding to FIG. 3a, and details are not described herein again.

In some embodiments, the execution module 105 includes: an execution unit 1051 and a first writing unit 1052. The execution unit 1051 is configured to execute the service-logic-contract calling transaction through the service logic contract in the second context, to obtain the transaction execution result. The first writing unit 1052 is configured to write the transaction execution result into the second context corresponding to the target proxy contract.

For specific implementations of the execution unit 1051 and the first writing unit 1052, reference may be made to the description of operation S105 in the foregoing embodiment corresponding to FIG. 3a, and details are not described herein again.

In some embodiments, the service-logic-contract calling transaction includes transaction data and a to-be-called function name, the to-be-called function name representing a name of a function that needs to be called in the service logic contract and that is configured for executing the transaction data. The execution unit 1051 includes: a function determining subunit 10511, a data acquisition subunit 10512, and an execution subunit 10513. The function determining subunit 10511 is configured to acquire a to-be-called function in the service logic contract based on the to-be-called function name. The data acquisition subunit 10512 is configured to acquire historical transaction data for the transaction data in the second context based on the to-be-called function. The execution subunit 10513 is configured to execute the to-be-called function based on the transaction data and the historical transaction data, to obtain the transaction execution result.

For specific implementations of the function determining subunit 10511, the data acquisition subunit 10512, and the execution subunit 10513, reference may be made to the description of operation S105 in the foregoing embodiment corresponding to FIG. 3a, and details are not described herein again.

In some embodiments, the data processing apparatus 1 further includes: a second receiving module 106, a fourth acquisition module 107, a first deployment module 108, and a first writing module 109. The second receiving module 106 is configured to receive a proxy contract deployment transaction associated with a first object, where the proxy contract deployment transaction includes a management contract address. The fourth acquisition module 107 is configured to acquire a management contract indicated by the management contract address when a consensus on the proxy contract deployment transaction is passed. The first deployment module 108 is configured to deploy a target proxy contract associated with the service logic contract through the management contract. The first writing module 109 is configured to write a proxy contract address corresponding to the target proxy contract and the first object on-chain address corresponding to the first object into the management contract, correlatively.

For specific implementations of the second receiving module 106, the fourth acquisition module 107, the first deployment module 108, and the first writing module 109, reference may be made to the description of operation S203 in the foregoing embodiment corresponding to FIG. 4, and details are not described herein again.

In some embodiments, the management contract includes proxy contract deployment code and a service logic contract address corresponding to the service logic contract. The first deployment module 108 includes: a creation unit 1081 and a second writing unit 1082. The creation unit 1081 is configured to create an initial proxy contract by executing the proxy contract deployment code. The second writing unit 1082 is configured to write the service logic contract address into the initial proxy contract to obtain the target proxy contract associated with the service logic contract.

For specific implementations of the creation unit 1081 and the second writing unit 1082, reference may be made to the description of operation S203 in the foregoing embodiment corresponding to FIG. 4, and details are not described herein again.

In some embodiments, the data processing apparatus 1 further includes: a third receiving module 110, a creation module 111, and a second writing module 112. The third receiving module 110 is configured to receive a management contract deployment transaction associated with a management object, where the management contract deployment transaction includes management contract code, proxy contract deployment code, and the service logic contract address. The creation module 111 is configured to create an initial management contract by executing the management contract code when a consensus on the management contract deployment transaction is passed. The second writing module 112 is configured to write the proxy contract deployment code and the service logic contract address into the initial management contract, to obtain the management contract.

For specific implementations of the third receiving module 110, the creation module 111, and the second writing module 112, reference may be made to the descriptions of operation S202 in the foregoing embodiment corresponding to FIG. 4, and details are not described herein again.

In some embodiments, the data processing apparatus 1 further includes: a first transmission module 113. The first transmission module 113 is configured to transmit a management contract address corresponding to the management contract to a service server, so that the service server generates a proxy contract deployment transaction carrying the management contract address when receiving a proxy contract deployment request associated with the first object for the service logic contract, where the proxy contract deployment transaction is configured for deploying the target proxy contract for the first object.

For a specific implementation of the first transmission module 113, reference may be made to the description of operation S202 in the foregoing embodiment corresponding to FIG. 4, for example, and details are not described herein again.

In some embodiments, the data processing apparatus 1 further includes: a fourth receiving module 114, a second deployment module 115, and a second transmission module 116. The fourth receiving module 114 is configured to receive a service-logic-contract deployment transaction associated with the management object, where the service-logic-contract deployment transaction includes service logic contract code. The second deployment module 115 is configured to deploy the service logic contract by executing the service logic contract code when a consensus on the service-logic-contract deployment transaction is passed. The second transmission module 116 is configured to transmit the service logic contract address corresponding to the service logic contract to the management object when the service logic contract is successfully deployed.

For specific implementations of the fourth receiving module 114, the second deployment module 115, and the second transmission module 116, reference may be made to the descriptions of operation S201 in the foregoing embodiment corresponding to FIG. 4, and details are not described herein again.

In some embodiments, the data processing apparatus 1 further includes: a permission determining module 117 and a consensus module 118. The permission determining module 117 is configured to acquire a management object on-chain address corresponding to the management object. The permission determining module 117 is further configured to transmit permission error prompt information to the management object when it is determined that the management object on-chain address does not have a management contract deployment permission. The consensus module 118 is configured to initiate a consensus request for the management contract deployment transaction to a consensus network when it is determined that the management object on-chain address has the management contract deployment permission, so that the consensus network performs consensus processing on the management contract deployment transaction to obtain a consensus result. The consensus module 118 is further configured to determine that the consensus on the management contract deployment transaction is passed when the consensus result is a consensus passing result.

For specific implementations of the permission determining module 117 and the consensus module 118, reference may be made to the optional description of operation S202 in the foregoing embodiment corresponding to FIG. 4, and details are not described herein again.

In some embodiments, the data processing apparatus 1 further includes: a search module 119. The search module 119 is configured to search the one or more proxy contract addresses in the management contract based on the first object on-chain address corresponding to the first object. The search module 119 is further configured to call the second acquisition module when finding a proxy contract address associated with the first object on-chain address corresponding to the first object in the one or more proxy contract addresses. The search module 119 is further configured to transmit proxy contract registration guidance information to the first object when not finding the proxy contract address associated with the first object on-chain address corresponding to the first object in the one or more proxy contract addresses.

For a specific implementation of the search module 119, reference may be made to the optional description of operation S103 in the foregoing embodiment corresponding to FIG. 3a, and details are not described herein again.

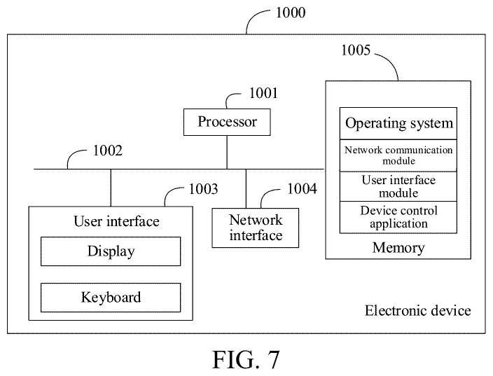

FIG. 7 is a schematic structural diagram of an electronic device according to an embodiment of the present disclosure. As shown in FIG. 7, the data processing apparatus 1 in the foregoing embodiment corresponding to FIG. 6 may be applied to an electronic device 1000. The electronic device 1000 may include: a processor 1001, a network interface 1004, and a memory 1005. In addition, the electronic device 1000 may further include: a user interface 1003 and at least one communication bus 1002. The communication bus 1002 is configured to implement connection and communication between the components. The user interface 1003 may include a display, a keyboard, and in some embodiments, the user interface 1003 may further include a standard wired interface and a standard wireless interface. In some embodiments, the network interface 1004 may include a standard wired interface and a standard wireless interface (such as a Wi-Fi interface). The memory 1005 may be a high-speed RAM memory, or may be a non-volatile memory, for example, at least one magnetic disk memory. In some embodiments, the memory 1005 may further be at least one storage apparatus that is located far away from the processor 1001. As shown in FIG. 7, the memory 1005 used as a computer-readable storage medium may include an operating system, a network communication module, a user interface module, and a device-control application.

In the electronic device 1000 shown in FIG. 7, the network interface 1004 may provide a network communication network element. The user interface 1003 is mainly configured to provide an input interface for a user. The processor 1001 may be configured to call the device control application stored in the memory 1005 to implement the blockchain-based data processing method provided in the embodiments of the present disclosure.

The electronic device 1000 described in the embodiments of the present disclosure can implement the descriptions of the data processing method in the foregoing embodiment corresponding to any one of FIG. 3a and FIG. 4. Details are not described herein again. In addition, the description of beneficial effects of the same method is not described herein again.

In addition, an embodiment of the present disclosure further provides a computer-readable storage medium. The computer-readable storage medium stores a computer program product executed by the data processing apparatus 1 mentioned above, and the computer program product includes computer executable instructions. When executing the program executable instructions, the processor can perform the descriptions of the foregoing data processing method in the foregoing embodiment corresponding to any one of FIG. 3a and FIG. 4. Therefore, details are not described herein again. In addition, the description of beneficial effects of the same method is not described herein again. For technical details that are not disclosed in the embodiments of the computer-readable storage medium of the present disclosure, refer to the method embodiments of the present disclosure.

The computer-readable storage medium may be a data processing apparatus provided in any one of the foregoing embodiments or an internal storage unit of the electronic device, for example, a hard disk or a main memory of the electronic device. The computer-readable storage medium may alternatively be an external storage device of the electronic device, for example, a removable hard disk, a smart media card (SMC), a secure digital (SD) card, or a flash card equipped on the electronic device. Further, the computer-readable storage medium may further include both an internal storage unit and an external storage device of the electronic device. The computer-readable storage medium is configured to store the computer program and another program and data that are required by the electronic device. The computer-readable storage medium may further be configured to temporarily store data that has been outputted or data to be outputted.

In addition, an embodiment of the present disclosure further provides a computer program product, the computer program product including computer executable instructions, the computer instructions being stored in a computer-readable storage medium. A processor of an electronic device reads the computer instructions from the computer-readable storage medium, and executes the computer instructions, to cause the electronic device to perform the method in the foregoing embodiment corresponding to any one of FIG. 3a and FIG. 4.

Accordingly, as disclosed, when the first object needs to apply a related function provided by the service logic contract, the service logic contract may be called through the proxy contract and a related transaction execution result is stored. Therefore, the first object does not need to deploy a service logic contract with a more complex function and a larger amount of code on the blockchain in advance, but only deploys a proxy contract with a small amount of code on the blockchain in advance. The amount of code that needs to be deployed is reduced, which can indirectly reduce consumption costs during contract deployment. In addition, the amount of code of a contract that needs to be stored and maintained subsequently is reduced, which can reduce waste of system resources.

In the specification, claims, and accompanying drawings of embodiments of the present disclosure, the terms “first” and “second” are intended to distinguish between different objects but do not indicate a particular order. In addition, terminologies “comprise” and any variations thereof are intended to indicate non-exclusive inclusion. For example, a process, method, apparatus, product, or device that includes a series of operations or modules is not limited to the listed operations or units; and instead, further includes an operation or a module that is not listed, or further includes another operation or unit that is intrinsic to the process, method, apparatus, product, or device.

The term module (and other similar terms such as submodule, unit, subunit, etc.) in the present disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

A person of ordinary skill in the art may be aware that, in combination with examples of units and algorithm operations described in the embodiments disclosed in this specification, the present disclosure may be implemented by using electronic hardware, computer software, or a combination thereof. To clearly describe interchangeability between the hardware and the software, compositions and operations of each example have been generally described according to network elements in the foregoing descriptions. Whether the network elements are executed in a mode of hardware or software depends on particular applications and design constraint conditions of the technical solutions. A person skilled in the art may use different methods to implement the described network elements for each particular application, but it is to not be considered that the implementation goes beyond the scope of the present disclosure.

What is disclosed above is merely exemplary embodiments of the present disclosure, and certainly is not intended to limit the protection scope of the present disclosure. Therefore, equivalent variations made in accordance with the claims of the present disclosure shall fall within the scope of the present disclosure.

What is claimed is:

1. A blockchain-based data processing method, performed by a blockchain node, comprising:
receiving a service-logic-contract calling transaction associated with a first object;
acquiring a management contract when a consensus on the service-logic-contract calling transaction is passed, the management contract storing one or more proxy contract addresses, each proxy contract address being associated with a different object on-chain address, and a proxy contract corresponding to each proxy contract address being associated with a service logic contract;
acquiring, in the one or more proxy contract addresses, a proxy contract address associated with a first object on-chain address corresponding to the first object as a target proxy contract address through the management contract;
acquiring a target proxy contract corresponding to the target proxy contract address, and acquiring the service logic contract through the target proxy contract, the service logic contract being associated with the target proxy contract; and
executing the service-logic-contract calling transaction through the service logic contract to obtain a transaction execution result, and writing the transaction execution result into the target proxy contract, the transaction execution result in the target proxy contract being associated with the first object.

2. The method according to claim 1, wherein acquiring the target proxy contract corresponding to the target proxy contract address, and acquiring the service logic contract through the target proxy contract comprise:
switching, in a first context, the first context to a second context in a process of switching to call the target proxy contract corresponding to the target proxy contract address through the management contract, wherein the first context is a context corresponding to the management contract; and the second context is a context corresponding to the target proxy contract; and
delegatecalling the service logic contract through the target proxy contract in the second context, wherein the second context remains unchanged when delegating to call the service logic contract.

3. The method according to claim 2, wherein executing the service-logic-contract calling transaction through the service logic contract to obtain the transaction execution result, and writing the transaction execution result into the target proxy contract comprise:
executing the service-logic-contract calling transaction through the service logic contract in the second context, to obtain the transaction execution result; and
writing the transaction execution result into the second context corresponding to the target proxy contract.

4. The method according to claim 3, wherein the service-logic-contract calling transaction comprises transaction data and a function name, the function name representing a name of a function that needs to be called in the service logic contract and that is configured for executing the transaction data; and
executing the service-logic-contract calling transaction through the service logic contract in the second context, to obtain the transaction execution result comprises:
acquiring a function in the service logic contract based on the function name;
acquiring historical transaction data for the transaction data in the second context based on the function; and
executing the function based on the transaction data and the historical transaction data, to obtain the transaction execution result.

5. The method according to claim 1, further comprising:
receiving a proxy contract deployment transaction associated with the first object, wherein the proxy contract deployment transaction comprises a management contract address;
acquiring a management contract indicated by the management contract address when a consensus on the proxy contract deployment transaction is passed;
deploying a target proxy contract associated with the service logic contract through the management contract; and
writing a proxy contract address corresponding to the target proxy contract and the first object on-chain address corresponding to the first object into the management contract, correlatively.

6. The method according to claim 5, wherein the management contract comprises proxy contract deployment code and a service logic contract address corresponding to the service logic contract; and
deploying the target proxy contract associated with the service logic contract through the management contract comprises:
creating an initial proxy contract by executing the proxy contract deployment code; and
writing the service logic contract address into the initial proxy contract to obtain the target proxy contract associated with the service logic contract.

7. The method according to claim 1, further comprising:
receiving a management contract deployment transaction associated with a management object, wherein the management contract deployment transaction comprises management contract code, proxy contract deployment code, and the service logic contract address;
creating an initial management contract by executing the management contract code when a consensus on the management contract deployment transaction is passed; and
writing the proxy contract deployment code and the service logic contract address into the initial management contract, to obtain the management contract.

8. The method according to claim 7, further comprising:
transmitting a management contract address corresponding to the management contract to a service server for generating a proxy contract deployment transaction carrying the management contract address when receiving a proxy contract deployment request associated with the first object for the service logic contract, wherein the proxy contract deployment transaction is configured for deploying the target proxy contract for the first object.

9. The method according to claim 7, further comprising:
receiving a service-logic-contract deployment transaction associated with the management object, wherein the service-logic-contract deployment transaction comprises service logic contract code;
deploying the service logic contract by executing the service logic contract code when a consensus on the service-logic-contract deployment transaction is passed; and
transmitting the service logic contract address corresponding to the service logic contract to the management object when the service logic contract is successfully deployed.

10. The method according to claim 7, further comprising:
acquiring a management object on-chain address corresponding to the management object;
transmitting permission error prompt information to the management object when it is determined that the management object on-chain address does not have a management contract deployment permission;
initiating a consensus request for the management contract deployment transaction to a consensus network when it is determined that the management object on-chain address has the management contract deployment permission, wherein the consensus network performs consensus processing on the management contract deployment transaction to obtain a consensus result; and
determining that the consensus on the management contract deployment transaction is passed when the consensus result is a consensus passing result.

11. The method according to claim 1, further comprising:
searching the one or more proxy contract addresses in the management contract based on the first object on-chain address corresponding to the first object; and
when finding a proxy contract address associated with the first object on-chain address corresponding to the first object in the one or more proxy contract addresses, performing following operations: acquiring, in the one or more proxy contract addresses, the proxy contract address associated with the first object on-chain address corresponding to the first object as the target proxy contract address through the management contract; and
when not finding the proxy contract address associated with the first object on-chain address corresponding to the first object in the one or more proxy contract addresses, transmitting proxy contract registration guidance information to the first object.

12. An electronic device, comprising:
one or more processors, a memory, and a network interface, the one or more processors being connected to the memory and the network interface, the network interface being configured to provide a data communication function, and the memory being configured to store computer executable instructions that, when being executed, cause the one or more processors to perform:
receiving a service-logic-contract calling transaction associated with a first object;
acquiring a management contract when a consensus on the service-logic-contract calling transaction is passed, the management contract storing one or more proxy contract addresses, each proxy contract address being associated with a different object on-chain address, and a proxy contract corresponding to each proxy contract address being associated with a service logic contract;
acquiring, in the one or more proxy contract addresses, a proxy contract address associated with a first object on-chain address corresponding to the first object as a target proxy contract address through the management contract;
acquiring a target proxy contract corresponding to the target proxy contract address, and acquiring the service logic contract through the target proxy contract, the service logic contract being associated with the target proxy contract; and
executing the service-logic-contract calling transaction through the service logic contract to obtain a transaction execution result, and writing the transaction execution result into the target proxy contract, the transaction execution result in the target proxy contract being associated with the first object.

13. The device according to claim 12, wherein the one or more processors are configured to perform:
switching, in a first context, the first context to a second context in a process of switching to call the target proxy contract corresponding to the target proxy contract address through the management contract, wherein the first context is a context corresponding to the management contract; and the second context is a context corresponding to the target proxy contract; and
delegatecalling the service logic contract through the target proxy contract in the second context, wherein the second context remains unchanged when delegating to call the service logic contract.

14. The device according to claim 13, wherein the one or more processors are configured to perform:
executing the service-logic-contract calling transaction through the service logic contract in the second context, to obtain the transaction execution result; and
writing the transaction execution result into the second context corresponding to the target proxy contract.

15. The device according to claim 14, wherein the service-logic-contract calling transaction comprises transaction data and a function name, the function name representing a name of a function that needs to be called in the service logic contract and that is configured for executing the transaction data; and
the one or more processors are configured to perform:
acquiring a function in the service logic contract based on the function name;
acquiring historical transaction data for the transaction data in the second context based on the function; and
executing the function based on the transaction data and the historical transaction data, to obtain the transaction execution result.

16. The device according to claim 12, wherein the one or more processors are configured to perform:
receiving a proxy contract deployment transaction associated with the first object, wherein the proxy contract deployment transaction comprises a management contract address;
acquiring a management contract indicated by the management contract address when a consensus on the proxy contract deployment transaction is passed;
deploying a target proxy contract associated with the service logic contract through the management contract; and
writing a proxy contract address corresponding to the target proxy contract and the first object on-chain address corresponding to the first object into the management contract, correlatively.

17. The device according to claim 16, wherein the management contract comprises proxy contract deployment code and a service logic contract address corresponding to the service logic contract; and
the one or more processors are configured to perform:
creating an initial proxy contract by executing the proxy contract deployment code; and
writing the service logic contract address into the initial proxy contract to obtain the target proxy contract associated with the service logic contract.

18. The device according to claim 12, wherein the one or more processors are configured to perform:
receiving a management contract deployment transaction associated with a management object, wherein the management contract deployment transaction comprises management contract code, proxy contract deployment code, and the service logic contract address;
creating an initial management contract by executing the management contract code when a consensus on the management contract deployment transaction is passed; and
writing the proxy contract deployment code and the service logic contract address into the initial management contract, to obtain the management contract.

19. The device according to claim 18, wherein the one or more processors are configured to perform:
transmitting a management contract address corresponding to the management contract to a service server for generating a proxy contract deployment transaction carrying the management contract address when receiving a proxy contract deployment request associated with the first object for the service logic contract, wherein the proxy contract deployment transaction is configured for deploying the target proxy contract for the first object.

20. A non-transitory computer-readable storage medium containing computer executable instructions that, when being executed, cause at least one processor to perform:
receiving a service-logic-contract calling transaction associated with a first object;
acquiring a management contract when a consensus on the service-logic-contract calling transaction is passed, the management contract storing one or more proxy contract addresses, each proxy contract address being associated with a different object on-chain address, and a proxy contract corresponding to each proxy contract address being associated with a service logic contract;
acquiring, in the one or more proxy contract addresses, a proxy contract address associated with a first object on-chain address corresponding to the first object as a target proxy contract address through the management contract;
acquiring a target proxy contract corresponding to the target proxy contract address, and acquiring the service logic contract through the target proxy contract, the service logic contract being associated with the target proxy contract; and
executing the service-logic-contract calling transaction through the service logic contract to obtain a transaction execution result, and writing the transaction execution result into the target proxy contract, the transaction execution result in the target proxy contract being associated with the first object.
